(19) United States
(12) Patent Application Publication
(10) Pub. No.: US 2009/0125368 A1
(43) Pub. Date: May 14, 2009

(54) System and Method for Scheduling Work Orders

(76) Inventor: Jovo (John) Vujicic, Hamilton (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, CA

(21) Appl. No.: 12/252,986

(22) Filed: Oct. 16, 2008

Related U.S. Application Data
(60) Provisional application No. 60/980,213, filed on Oct. 16, 2007.

(51) Int. Cl. G06Q 10/00; G06N 5/02; G06F 3/048

(52) U.S. Cl. 705/9; 706/47; 715/760

(57) ABSTRACT

A method of scheduling work orders maintained within an enterprise resource planning (ERP) system comprises maintains key performance indicator (KPI) information associated in real-time with the work orders. The KPI information is present to facilitate decisions related to the scheduling. In response to user input scheduling selected work orders, changes to selected work orders may be committed in the ERP system Orders may be tentatively scheduled and tentative changes maintained without committing to the ERP system. KPI information may be updated for the tentative changes and presented. Further the method may comprise receiving user input specifying a particular date to schedule to; receiving user input to specify particular work orders to schedule; receiving user input to schedule the particular work orders to the particular date; and tentatively scheduling in accordance with said user input to schedule.

### CROSS-REFERENCE

This application claims the benefit of U.S. Provisional Application No. 60/980,213 filed Oct. 16, 2007 under 35 USC §119.

### FIELD

This application relates to asset management and in particular to a system and method for scheduling work orders and assigning manpower resources to the work that is being scheduled.

### BACKGROUND

Organizations incurring a significant backlog of maintenance or employee work orders are confronted with difficult decisions concerning what work orders will be scheduled, when they will be scheduled, and who will complete them. In large organizations having many assets to maintain, many trades people or types of trades people to service the assets, these difficulties are compounded further.

While there are various scheduling programs providing some degree of effectiveness in tackling these issues, they may not be effective in dealing with large numbers of work orders over multiple weeks with personnel or groups of personnel with varying degrees of qualifications. The work orders themselves may be incomplete or otherwise incapable of being fulfilled if scheduled. Further, these solutions are cumbersome and not intuitive, leading to inefficient work allocation. Another common dilemma is when a work order is presumed to have been planned properly, put out for scheduling and associated with a specific resource, it is discovered that there are critical flaws in the work order (such as no human resources planned, no descriptions of the task to be done, dates that are already past due, etc.). This results in further wasted labor, downtime and re-work. When work is scheduled there is rarely, if ever, any real time indication of what the impact on labor utilization is being affected by the work scheduled and little, if any, capacity to manage the availability of the very same resources on an ongoing daily basis (to allow for reduced or increased availability due to illness, overtime, etc.). Lastly, even when individuals responsible for scheduling are trying to execute some from of scheduling, they rarely, if at all, have any indication of the impact of the schedule on their departmental budgets. They may require such substantive parts that the cost of the scheduled work exceeds available funds and either they break their budget or the parts are thus not purchased on time and labor is left unscheduled. Either of these outcomes are less than desirable and result in significant financial costs to these organizations.

As a result, organizations may not be using their personnel and other resources to a desired level of efficiency: employees may be working unnecessary overtime or too little, scheduling errors may occur, and otherwise unnecessary outside assistance may be required at a high cost and with little advance warning. All of the foregoing being dealt with in an environment where it is difficult, if not impossible, to manage budgets properly in parallel.

In many standard applications there is no capacity to manage crews of resources. Alternatively, if they manage crews it is not in a dynamic fashion that lends itself to scheduling as the data is normally managed in a larger human resources solution that does not allow for the quick changes necessary in a maintenance scheduling environment.

There is a further need for such a program to be easy for work personnel, foreman, and managers to use. Accurate and quick statistical projections and analyses are also desired as often times when one does do the scheduling they cannot measure the cumulative effect their schedule has on the labor resource pool or budget available to them. This will often result in under or over scheduling, and under or over budget utilization.

### SUMMARY

A scheduler application interacts with existing databases of work orders, allowing users to efficiently schedule large numbers of work orders to specific dates, and to assign specific crews of trades people, specific trades people themselves, or combinations of people and crews. The scheduler application simultaneously provides numerous real-time key performance indicators for evaluating the organization's productivity both in labor use and budgetary impact. The System and Method for Scheduling Work Orders interacts with existing third-party databases to provide efficient and useable scheduling services and graphical statistical measurements of a schedule's performance to ensure the scheduling of properly planned work orders in a manner that will leverage the resources available to the organization with a view to maximizing their return on investment in their labor pool while, at the same time, allowing them to stay within their budgetary constraints on a month-by-month basis.

The work order scheduler application method may contain one or more of the following features:

Work Order Quality Check (Planning): Provides an interface for verifying that work orders are ready for scheduling. Rules are applied via a rules engine. Rules may be edited or created for verifying the work orders. Deficient work orders may be edited to be made ready. High value work orders can be expedited through the scheduling process.

Scheduling: Provides users with method of scheduling verified work orders using as little as three simple operations.

Time Entry Allows users to enter the time they worked for each day and each work order they have been scheduled to work on.

Crew Building Allows certain users to create groups of resources (or crews) so that these crews can be scheduled as a group to certain work orders.

Key Performance Indicators: Provides statistical measurements of the schedule or work orders in numerical or graphical format in real-time and may be on the same interface as that on which the work orders are displayed.

Committing to the Database: Saves the information that has been updated through the internet-based user interface for the local work orders to the third-party database.

Availability: Provides the availability to build forward looking capacity for the labor pool and manage that capacity on an exception basis thereby ensuring as accurate as possible a reflection of the available resource/labor hours to which work can be scheduled and when those resources/labor are scheduled to be working.

Security: Provides the ability to restrict which users can see which portions of the application and further has the ability to restrict certain actions or events from being executed within the application. This helps ensure that people are not executing tasks which they are not authorized to do or from seeing data that is not appropriate to their station in the company.

In one aspect, there is provided a method of scheduling work orders maintained within an enterprise resource planning (ERP) system. The method comprises providing a user interface for a scheduling application configured to schedule said work orders in said ERP system; maintaining key performance indicator (KPI) information associated in real time with said work orders using said scheduling application; presenting said KPI information via said user interface to facilitate decisions related to said scheduling; and in response to user input scheduling selected work orders, committing changes to said selected work orders in said ERP system to implement the scheduling.

The method may comprise, in response to user input tentatively scheduling at least some of said work orders: maintaining changes to said work orders by said scheduling application without committing said changes to said ERP system; updating said KPI information; and presenting the updated KPI information via said user interface.

The method may comprise receiving user input specifying a particular date to schedule to; receiving user input to specify particular work orders to schedule; receiving user input to schedule the particular work orders to the particular date; and tentatively scheduling in accordance with said user input to schedule.

The method may further comprise receiving user input to commit changes to said ERP system to schedule said tentatively scheduled work orders.

In accordance with a feature of the method, the user interface may be configured to present work orders from said ERP system using user selectable filters. The method may comprise presenting work orders from said ERP system in accordance with user selectable filters, wherein the user interface is configured to selectively associate one or more of said work orders presented in accordance with said filters with resources to perform said work orders and a time period for performing said work orders in response to user input to schedule said work orders.

In one embodiment the scheduling application is configured to plan said work orders and the user interface is configured to permit a user to selectively verify, using planning rules, one or more of said work orders presented in accordance with said filters. The user interface may be configured to define particular planning rules in response to user input. The user interface may be configured to receive changes to work orders and selectively commit said changes to said ERP system to plan said work orders for scheduling.

The user interface may be web-based. The scheduling application may cooperatively execute with the ERP system using ERP system APIs.

The user interface may be configured to present work orders and KPI information and receive work order changes in accordance with user profiles to restrict users to performing certain scheduling and work order change functions. The method may comprise maintaining transaction records for each work order as it is scheduled. The method may further comprise providing a user interface for said transaction records for analyzing a scheduling process.

In accordance with another aspect, there is provided a computer system comprising one or more servers and user computers coupled thereto via a communication network for performing a method, in accordance with the method aspect, of scheduling work orders maintained within an enterprise resource planning (ERP) system.

In accordance with a further aspect there is provided a computer program product comprising instructions and data for execution by a processor to implement a method, in accordance with the method aspect, of scheduling work orders maintained within an enterprise resource planning (ERP) system.

### BRIEF DESCRIPTION OF THE DRAWINGS

FIG. 1 is a block diagram of a system for scheduling work orders in accordance with one embodiment.

FIGS. 2, 3 and 4 are screen shots of a planning interface for applying planning rules, including views for reviewing and creating such rules.

FIGS. 5 and 6 are screen shots of the planning interface including views for editing a work order in the planning stage.

FIG. 7 is a screen shot of a resource being added in the planning stage.

FIGS. 8 and 9 are screen shots of the planning interface showing a work order's operations view and the work order's resources view respectively.

FIGS. 10, 11 and 12 are screen shots of a crew builder interface, including views for creating a crew.

FIGS. 11 and 12 shows a user creating a crew in the crew builder.

FIGS. 13 and 14 are screen shots of an “employee weekly schedule”, referred to as the MySchedule, user interface depicting a view for trades people of a specific user's (i.e. trades person's) scheduled work orders and time worked being entered against the work orders.

FIG. 15 is a screen shot of a scheduling user interface (referred to as the “Supervisors Daily View”), depicting a view of the Work Orders scheduled for trades people. Supervisors are enabled to review the proposed schedule for their crew in advance. Subsequently, once the hours have been entered by the trades people in the “MySchedule” view, the hours worked by these employees submitted to the Supervisor can then be approved by the Supervisor. Once approved, the data may be committed to the EAM database.

FIG. 16 shows a representative Key Performance Indicator (“KPI”) providing a four-week forecast of resource-load information.

FIGS. 17, 18 and 19 depict screen shots of display selections for the KPIs in the same interface within which work orders are scheduled. The application also allows the user to select which KPIs will appear on their screen and will track this information by user.

FIGS. 20, 21 and 22 are screen shots of the scheduling interface depicting the scheduling of different crews.

FIGS. 23 and 24 are screen shots of the scheduling interface showing weekly and daily views, respectively, of the scheduled work orders.

FIG. 25 is a screenshot of a log-in interface.

The terms “WorkAlign”, “Viziya” and “EMPOWERING ERP ASSET MANAGEMENT SOLUTIONS” shown in the drawings or otherwise used herein are trademarks of Viziya Corp. All rights are reserved.

### DETAILED DESCRIPTION

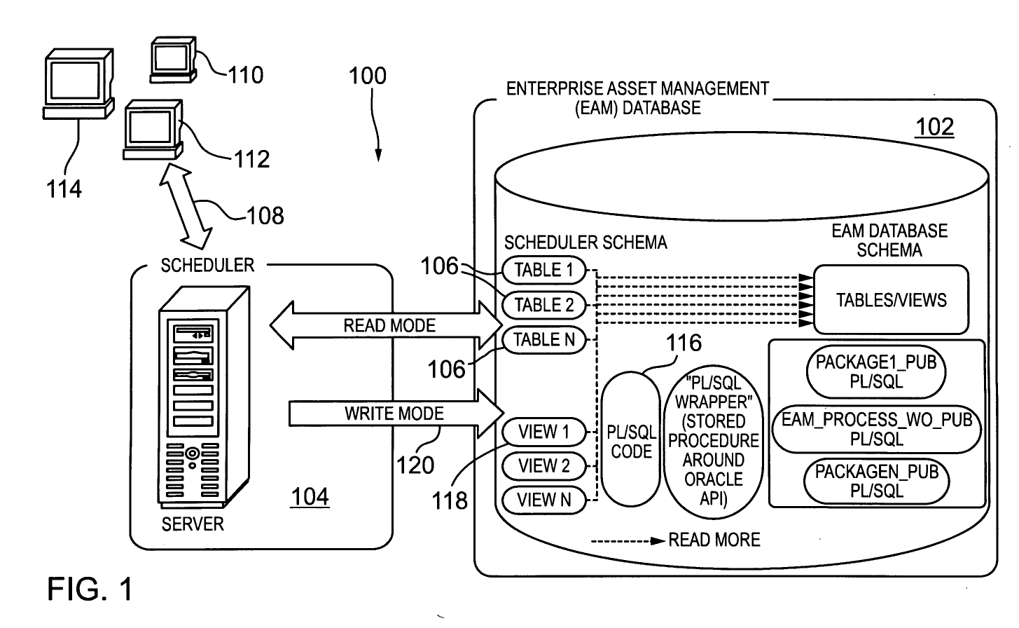

FIG. 1 is a block diagram, in accordance with an embodiment, of a system 100 for scheduling work orders. System 100 comprises an enterprise asset management (“EAM”) database, a scheduler application 104 (“Scheduler”), associated Scheduler tables 106 that are preferably stored within database 102 and a plurality of personal computers 110, 112 and 114 coupled to Scheduler 104 via a network connection such as the Internet 108.

EAM database 102 preferably comprises an ERP asset management system such as a third-party database solution (e.g. eAM™ from Oracle™ or PM™ from SAP™). Such EAM databases 102 provide facilities for creating, storing, updating and managing work orders. Additional information stored and maintained by such databases relates to resources such as particular trades people for performing the work orders, time card information, etc. The EAM database 102 provides a set of Application Programming Interfaces (“APIs”), or exposed code, which allows the Scheduler to interface to the EAM database and to obtain and update data such as work order schedule dates, resources, time card information, work order execution, etc (e.g. 116)

Scheduler 104 provides a user interface to the scheduling application through a web-based GUI for scheduling personnel, supervisors and trades. It provides interfaces to complete the planning of work orders, which are determined to be flawed by rules in the Scheduler; to schedule work orders to a specific day or to a week; to assign scheduled work orders to a crew, personnel shift, or to a crew as well as a specific shift; to input time and other work order performance information; and to roll-over, reschedule or move work orders, among other operations. Scheduler 104 extracts planned and approved work orders, labor availability and other EAM datasets for such scheduling operations. It further determines and maintains KPI information, storing as necessary to tables 106. Tables 106 are preferably stored within the same database as EAM database 102. A transactional record of every event that has occurred during the scheduling process can be stored in the tables 106 before the tables are posted back to the EAM database 102 (or primary ERP system). As well, Scheduler 104 is preferably co-located with EAM database 102 however it may be physically configured separately and coupled via ODBC or other connection.

Scheduler 104 provides pre-filters to the data sets that the GUI will display to the user. There is a method to be able delimit which work orders are displayed by the application at all and of these work orders which ones will appear in the Work Order Quality Check and then based on other criteria which ones will appear in the Scheduling page. This ensures corporate business processes are being enforced and limits the number of errors that can occur in the Scheduling process.

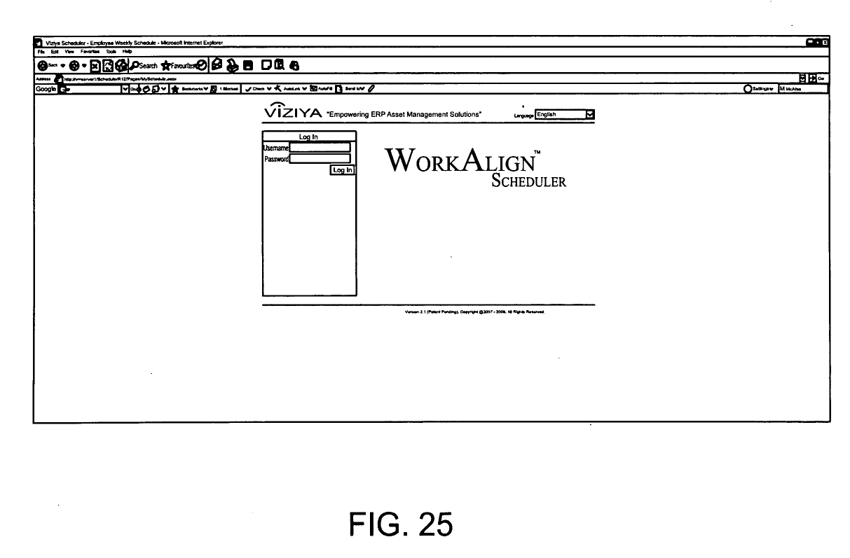

User's such as scheduling personnel, trades people supervisors (e.g. foremen) and trades people may be authorized to access the user interface of Scheduler 104 such as via account and password protection as is well known. An example log-in interface with password protection is depicted in FIG. 25. Scheduler 104 can be configured to utilize the native user name and security profiles of the native EAM database in order to avoid duplication of this security area. In the embodiment, the user interface is configured to operate via a web-based connection and within a browser-type application on personal computers such as desktops, laptops, etc. The application supports Single User Sign-On when the primary EAM solution supports Single User Sign-On and the customer has implemented same.

Work orders defined in EAM database 102 may include information such as:
a. name of organization;
b. name of department;
c. work order number;
d. description of the work order (what the work entails, for example);
e. name of the asset to be used for the completion of the work order;
f. description of the asset to be used for the completion of the work order;
g. type of work order;
h. priority (either high, medium, or low);
i. hours estimated for completion of work order;
j. status (either released, meaning completed, or draft, meaning to be completed);
k. start time; and
l. end time.

In one embodiment Scheduler 104 provides five primary functions: work order quality check (planning); scheduling; crew building; time entry, including the employee view (MySchedule) and foreman's view (Supervisors Daily Work Sheet); and KPI charts. These are described briefly and then in greater detail.

FIG. 1 shows one embodiment depicting the interaction of these five areas of functionality. Persons of ordinary skill in the art will understand that reference to one of the depicted PCs (110, 112, 114) applies to the other depicted PCs (110, 112, 114). Work order fields are selectively filtered and retrieved, (e.g. via the Internet or other network), from a third-party database. Within the planning stage the work orders are verified according to rules such as by using a rules engine in Scheduler 104. The verification rules can be manipulated, altered, and new rules can be created by authorized users. After the instances of the fields of a work order satisfies all applicable rules, the work order is ready for scheduling.

Within the Scheduling function the user can create and manipulate work order schedules. The work orders can be committed 120 to the EAM database to a week (i.e. for completion during that week), or to a specific day. They can be assigned to a crew (i.e. a collection of different resource types such as Mechanic, Welder, etc.), or to a shift. When Schedules are set and committed to the EAM database, the work orders making up the schedule are available for viewing by users who are granted such access. For example, in one embodiment each trades person is restricted to viewing only those work orders that the individual's crew is scheduled to perform. Similarly foremen or other supervisors can be restricted to viewing only those work orders for which their trades people are scheduled to perform. Different views (e.g. 118) of the work order schedules can be stored to the EAM database.

When schedules are committed 120 to the EAM database, as depicted in the embodiment in FIG. 1, users (e.g. trades people) can enter their hours worked for each work order for each day. The foreman can view all of the hours worked for each user for whom they are responsible. Foreman can then select the commit option, which will transmit the updated work order information to the EAM database via the Internet. Languages such as SQL can be used to store work order information to the EAM database 116.

KPI information may be retrieved to provide important performance measures to gauge scheduling practices and to assist with scheduling and other decisions.

### Planning

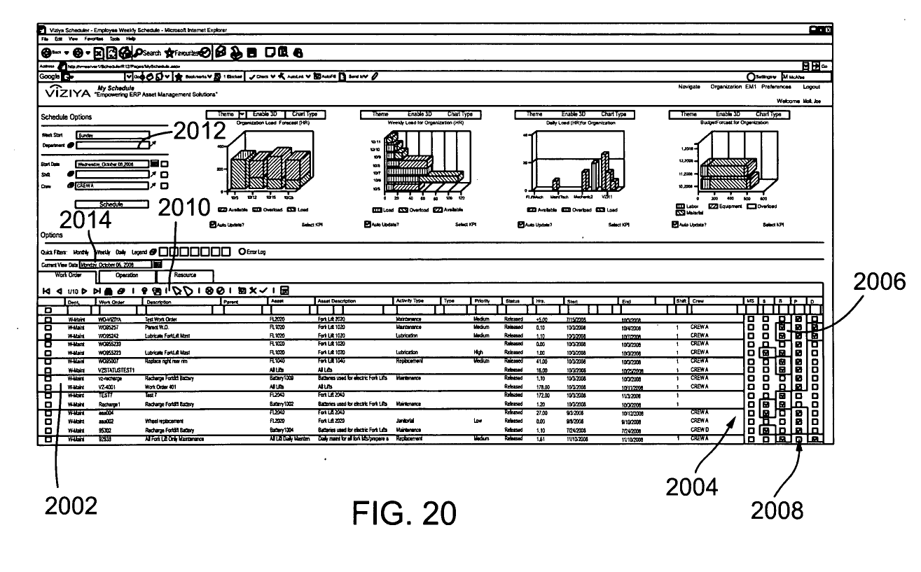

Scheduler 104 displays in a live view work order instances from the EAM database, as depicted in the architecture of FIG. 1. The work orders are displayed to the user. The displayed work orders are all found contained within one window pane which the user can page through the entire retrieved list. FIG. 20 shows a screenshot listing work orders 2002.

Scheduler 104 comprises software (instructions and data in a computer readable medium for execution by one or more processors) that is adapted to use the EAM databases' APIs in order to view the required work orders, as shown in FIG. 1. It is by using the APIs that the Scheduler can select the appropriate work orders or work order fields from the EAM database and, when appropriate, send back changes to commit to the database 102.

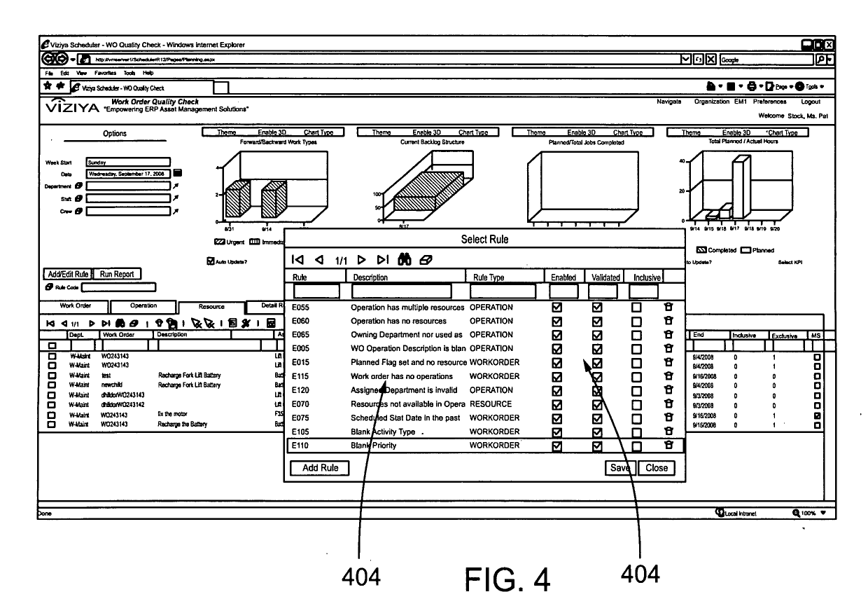

When the work orders are viewed and displayed on the Scheduler interface, they may not be sufficiently complete to be ready for scheduling. In one embodiment planning precedes scheduling. In accordance with the embodiment, planning operations apply pre-defined rules such as via a rules engine to the work orders to verify that they are suitable for scheduling as depicted in the embodiment in FIG. 4. Rules can be pre-defined or optionally created by the user to verify that the work orders adhere to the user's or organization's requirements. For example, a rule may indicate that for all work orders that require a certain resource, the start time must be later than a pre-defined date, otherwise the work order will not be verified. The reality is it would be an obsolete work order that is most likely redundant and would consume resources unnecessarily.

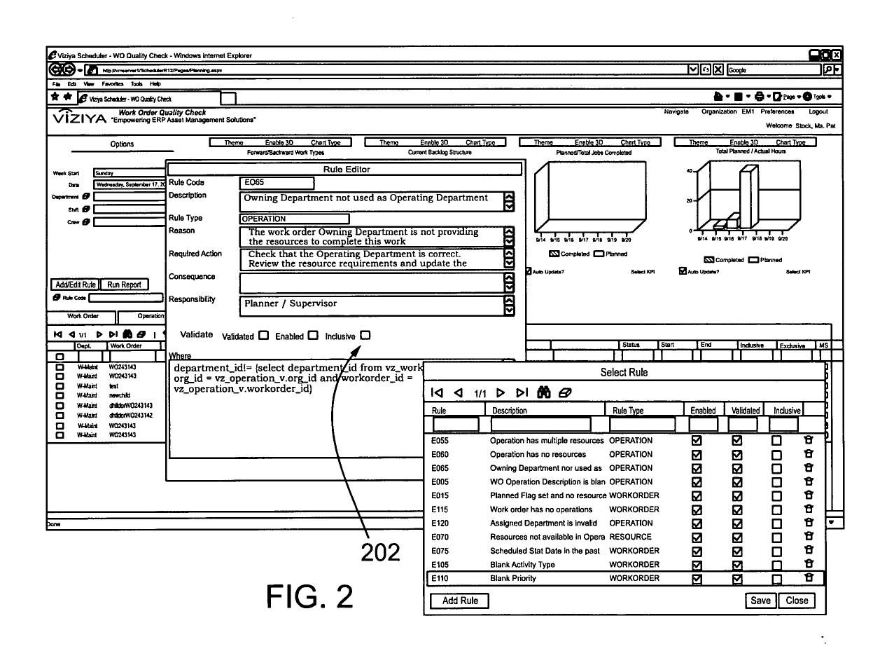

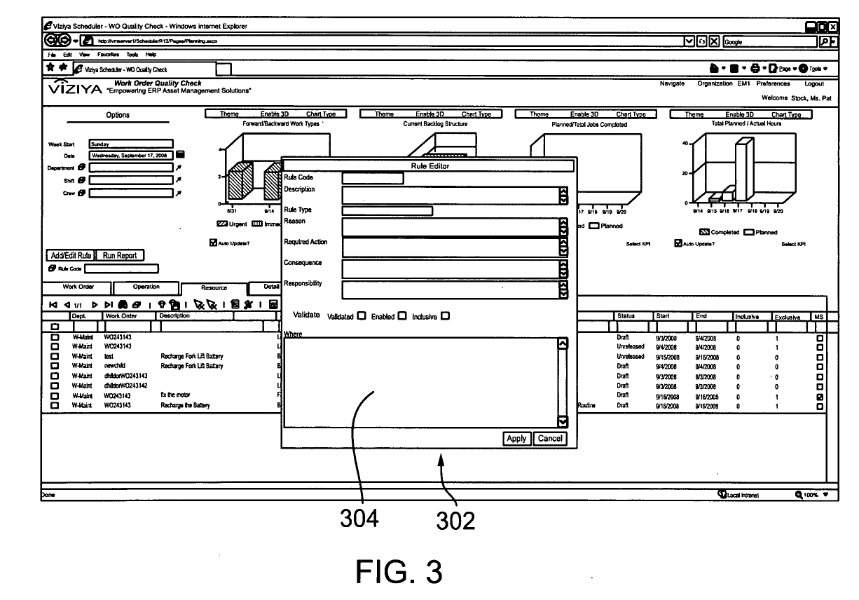

Rules can be created by users of the Scheduler, for example, to customize certain resource availability. FIG. 3 is a screen shot of the planning interface providing an example of the creation of a rule. Users can enter information in various fields 302 for the rule such as name, description, required action, etc. In the field labelled “Where:” 304, the user enters the rule regarding when the work order to which the rule applies will be validated. FIG. 2 depicts a rule that determines as flawed a work order where the owning department is not the same as the operating department 202.

Specific rules can be selected for application to specific levels of the work orders (at the Header, Operation or Resource level), as shown in the screen shot of FIG. 4. Rules are listed 402 in a new window with corresponding check boxes 404 to enable the chosen rules. Once enabled the rules will be applied to the work orders when the run report button 802 is selected from the planning interface.

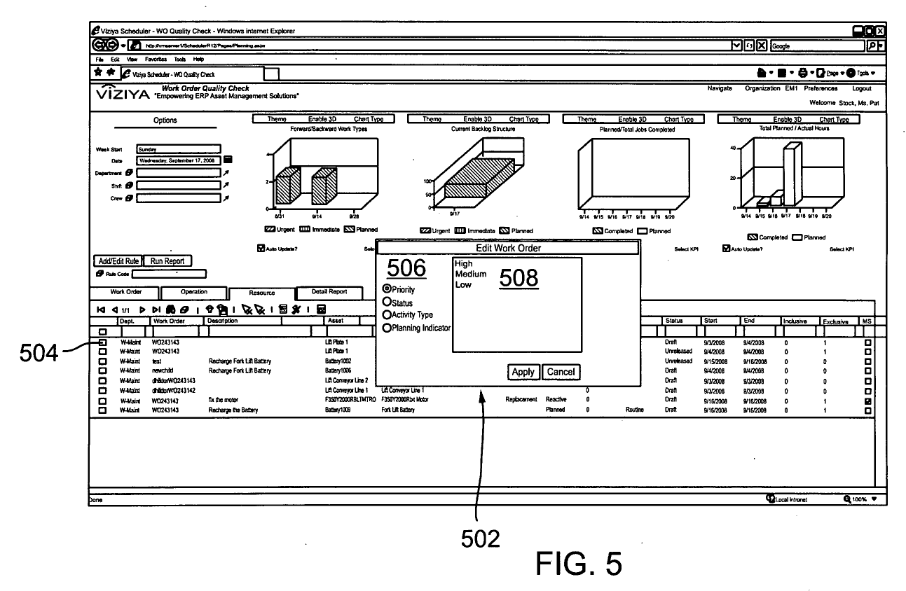

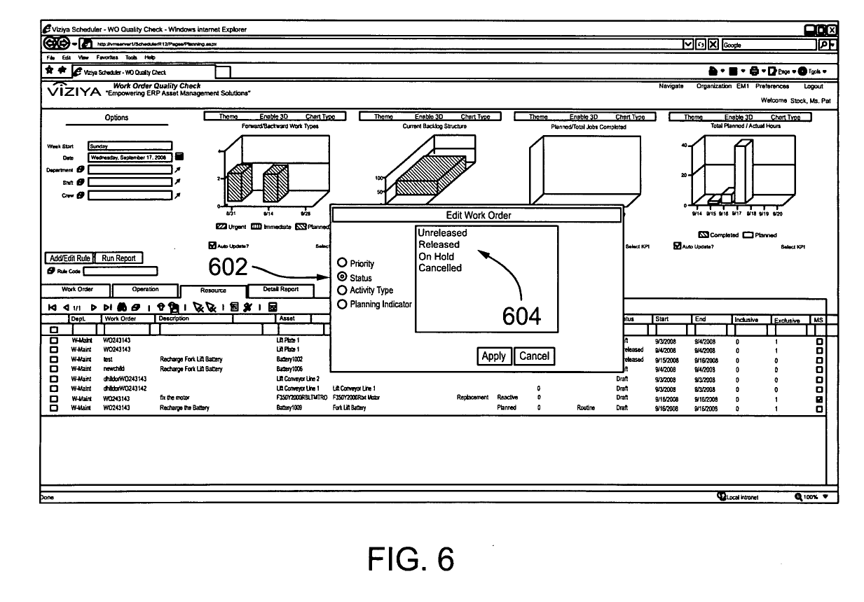

If an instance of a work order does not comply with a certain rule or certain rules after the run report button 802 is selected, the work order will appear as unreleased 804 in the list of work orders. Work order information for the work orders that do not comply with one or some of the rules can be edited so that it does comply such as is shown in FIGS. 5, 6, and 7. For example, if a rule indicates that work orders must have a priority in order to be ready for scheduling any work order instance that violates this rule can be edited to provide the appropriate status in order to comply with the rule. Changes to work orders are committed to the EAM database via Scheduler 104.

One can see here the priority for work orders being edited 502 to ensure compliance with certain rules. This is done by selecting the work order 504, selecting the priority button 506, in the new window, and then choosing the desired priority level 508. The status of the work orders can similarly be planned by selecting the status button 602 and choosing the corresponding status level 604. A status of unreleased indicates that the work order is not ready for the scheduling view. A work order can be edited as described so that it indicates released, indicating the work order is ready for the scheduling backlog view, regardless of the rules.

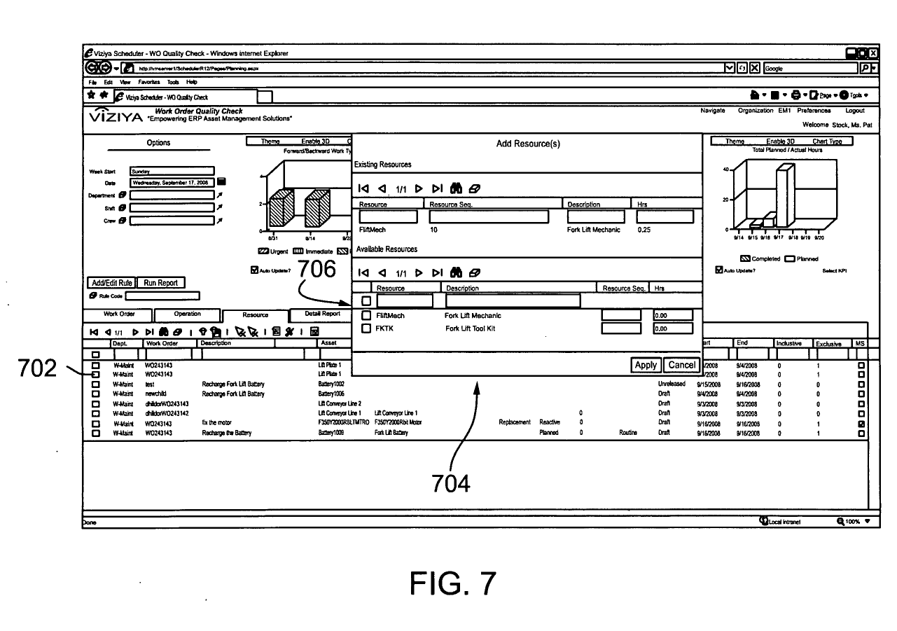

Additionally resources can be added to work orders in the planning stage as depicted in the embodiment of FIG. 7. Once a work order is selected 702 a new window appears 704 whereby users can select available resources to add to the work order 706.

After work orders are verified they are ready to proceed to the scheduling stage.

In addition to editing individual work orders, the user may mass change certain data elements of work orders in order to quickly ensure that mass numbers of work orders move from being incomplete in their planning to complete and ready for scheduling (not shown).

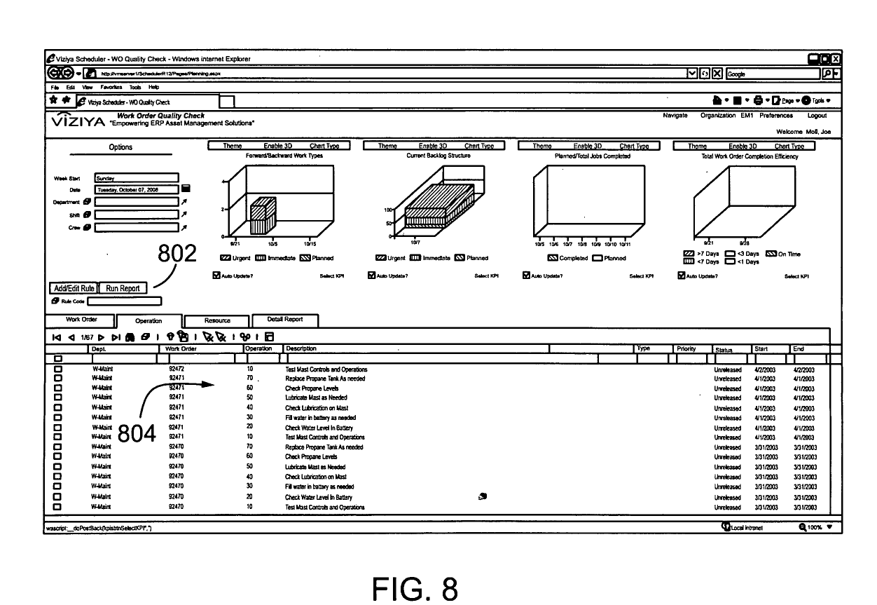

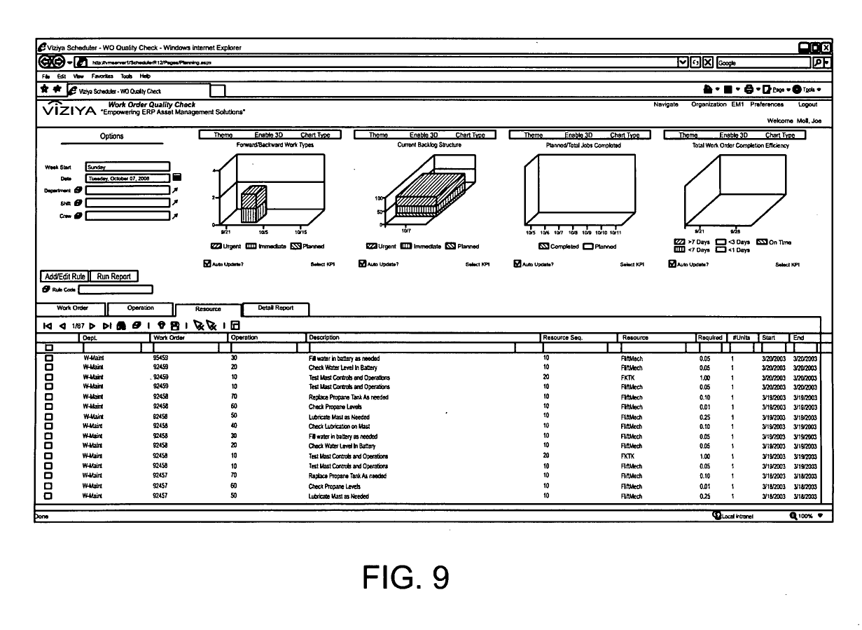

Planning can be completed at either a work order header, a work operations view (FIG. 8) or the work order's resource view (FIG. 9).

### Scheduling

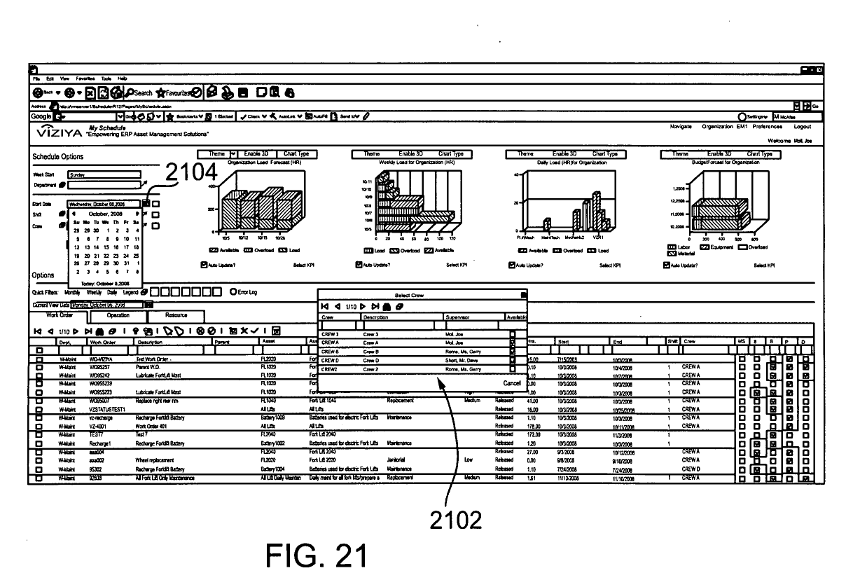

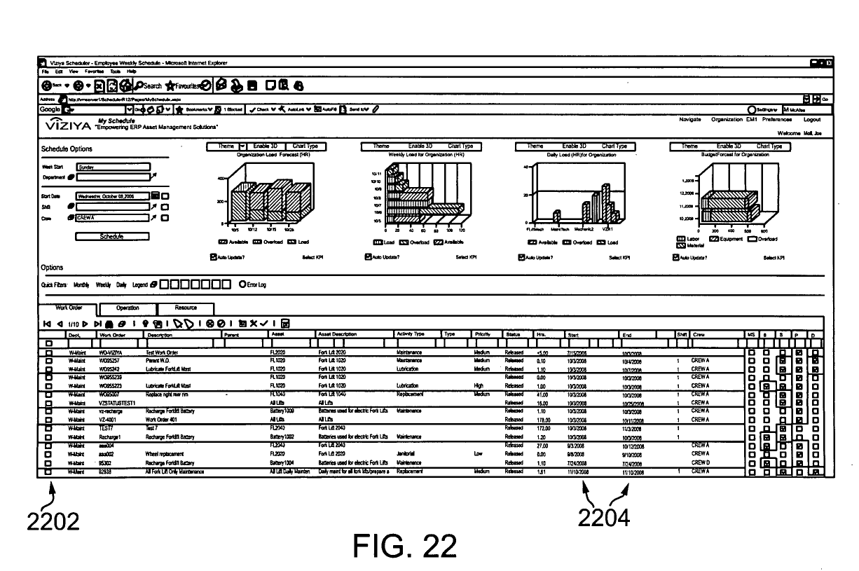

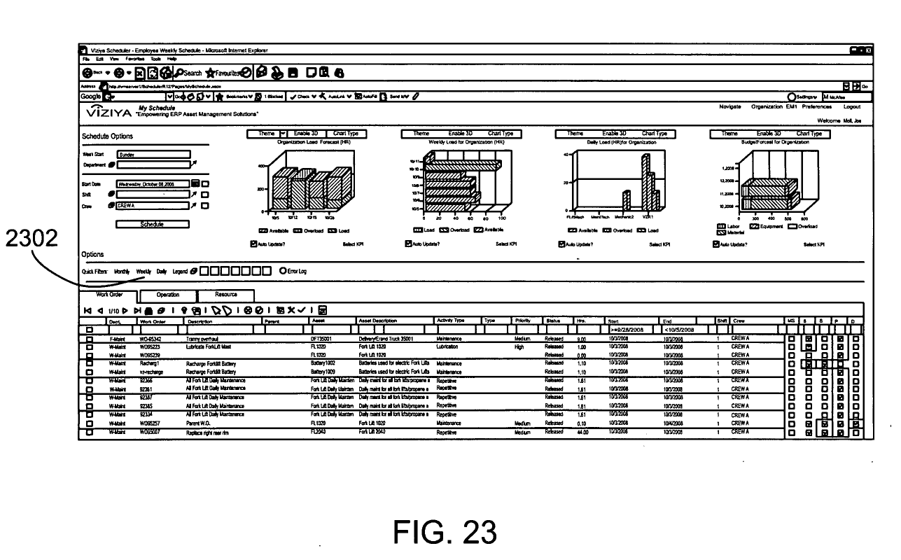

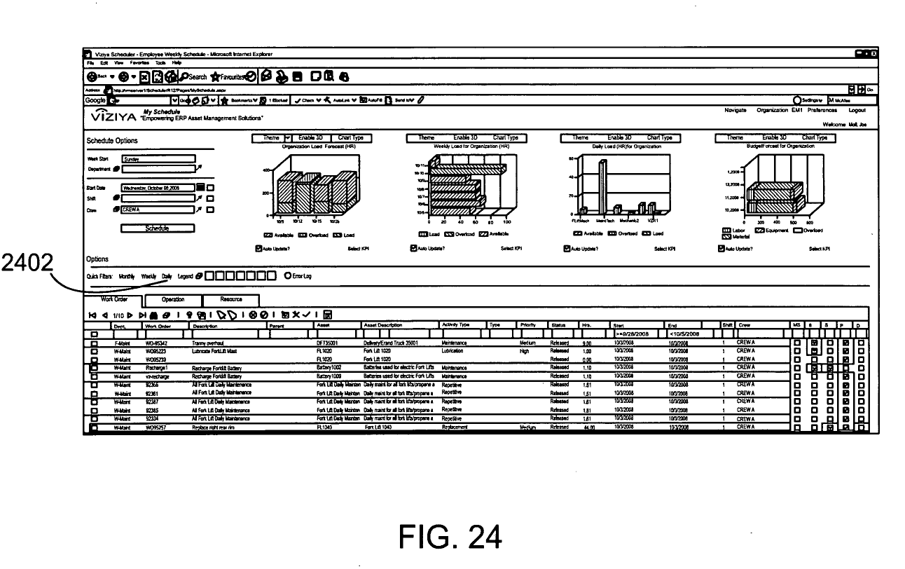

Scheduling operations are described with reference to screen shots of GUI views in FIGS. 20-24. Though shown in black and white, persons of ordinary skill in the art will appreciate that colour shading or other techniques or combined techniques may be employed to indicate work order status, etc. in the present embodiment reference is made to the use of colour by way of example. FIG. 20 is a screen shot of a representative scheduling system user interface in accordance with an embodiment showing a view for schedulers for filtering the display of work orders 2002. The view in FIG. 20 includes work orders that are not yet scheduled (i.e. work order backlog view) as indicated by the fact that the records are white 2004. In addition, views showing scheduled work orders by week 2302, day 2402 can be displayed such as in the examples of FIGS. 23 and 24. FIGS. 21 and 22 are screen shots of the scheduling system user interface of FIG. 20 depicting a view for schedulers of operations for a method of scheduling work orders that are ready for scheduling.

Once work orders have been verified, such as via the planning function, they are ready for scheduling. Such backlog work orders 2002 can be retrieved for viewing, editing and scheduling. The work orders are filtered and depicted in the interface as shown for example in FIGS. 20-24. By selecting various criteria from drop down menus or other GUI aspects, a user, such as scheduling personnel, can instruct Scheduler 104 to retrieve and display unscheduled work orders from database 102 that satisfy the specified criteria. Unscheduled work orders can be differentiated from scheduled work orders in a number of ways, for example in FIG. 20 the work orders have been filtered such that all work orders that have not been scheduled are displayed with a different background color than those that have been scheduled; work orders that have been scheduled, but not committed to the EAM database are highlighted in a blue collar across the entire record and have a boolean flag checked in the column labelled “S” and coloured blue 2006. Work orders that are scheduled and have been committed to the EAM database have a boolean in the column labelled “P” and are coloured bright green 2008. This is also applicable to work orders that have been marked as physically done with a Boolean in the column labelled “D” and coloured dark green and for those work orders that are considered a “break-in” on an existing schedule which will have a Boolean in the column labelled “B: and coloured red.

In the embodiment in FIG. 20 the work orders that have been verified in planning can be filtered by, for example, one, some or all of the column headers across the data spreadsheet at the bottom by providing criteria, for example in the first column with a header of “Dept” one could enter a specific department name and the view would then delimit the data being presented to only those work orders who have been assigned to the specific department. Once a user creates such a filtered view, the user can save the filtered preferences for a quick select and application in the future 2010.

After filtration the retrieved work orders are displayed such as in a list-based view of FIGS. 20 and 22 2005. Each column represents a field of the work order, and each row representing the work order instance contains the values in each field for that instance.

In the planning function work orders are required to contain expected start and end dates 2204 in order to be verified for scheduling, otherwise they can not be determined to be planned and ready for scheduling. These start and end dates are altered in the scheduling function by users selecting the dates from the calendar for when the work order is to be completed.

Work orders can also be viewed by selecting one of the following different detail levels as indicated in the embodiments shown in FIG. 20: header; operation; and resource detail levels 2014.

Work orders from EAM databases such as Oracle eAM and SAP PM, can include sub-orders (or operations), as is known to those skilled in the art. Viewing work orders by the work order header shows only the main work order views but does not show their associated sub-orders (or operations).

When work orders are viewed using the operation view (not shown), all operations making up each work order are displayed. For example, a work order may have three operations (such as disassemble motor, re-wind motor, reassemble motor); in the work order header view the primary work order will be shown; in the work order operation view three records for the work order will be shown corresponding to the three operations making up that work order. This allows for the user to choose whether to schedule specific operations separately or to schedule the entire work order.

Similarly, work orders viewed by resource will display all of the work order operations that can be seen from the operation view (not shown) and will also display all of the resources that comprise each work order's operation. For example, a work order operation to disassemble a motor may have two resources (such as a welder and a mechanic); in the work order operation view users will only see one record for the operation, whereas in the work order resource view users will see two records for this work order operation. Hence, users have the choice to block schedule all of the resources at once by selecting the Header and picking a date or to use the resource view and assign each resource specifically to a date.

The views in FIGS. 20-24 also illustrate selected KPI information. Importantly and as discussed further below, as the user selects different data by which to view work orders or schedule work orders, this data is updated, as applicable, for the period of reference. For example, should a user be looking to a particular future day or week to schedule work, the associated KPI information for that period is updated. The user can quickly see the state of affairs for that future date prior to adding more work to it. The user can determine down to the resource, the shift or the hours, how much labor capacity has been used and how much more room is left for additional work order scheduling. Preferably, the KPI information is presented graphically such as by way of bar graphs or other visual display techniques that illustrate the information for efficient and effective understanding. Different KPIs may be selected for displaying in the user interface views. KPIs can differ from function to function, for example there may be different KPIs displayed for the scheduling function than for the planning function. The KPIs preferably use colour codes which quickly show you when you have surpassed the available resources.

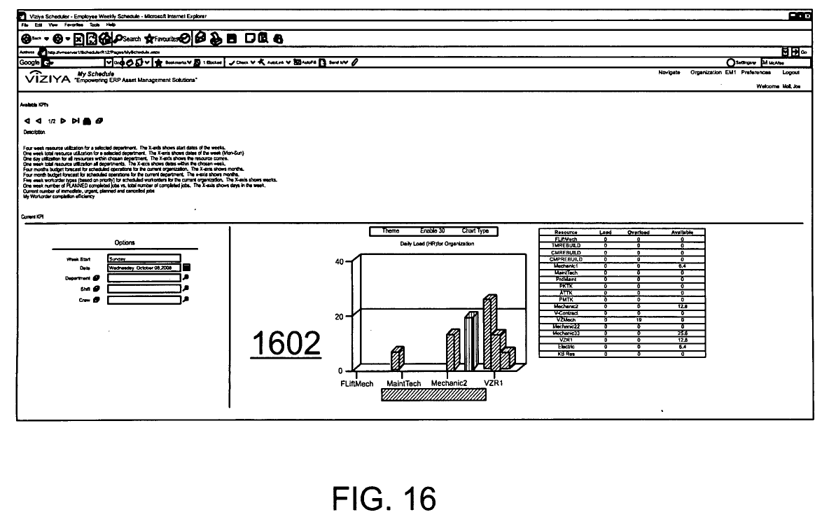

Additionally, the interface permits a user to specify a desired day that provides a start to a scheduling work week and a load percentage to allow for break in work orders as necessary. The interface also allows the users to set their monthly budget so that as they schedule work into the future the individual can measure the impact on available funds and budgets. KPIs are updated accordingly. See for example FIG. 16 showing a KPI of the four week labor forecast 1602. Underutilized resources are in grey whereas the overloaded resources are in orange.

To schedule a particular work order, start and end dates and specific resources (e.g. trades people) are provided to associate with the work order in the EAM database 102. With reference to FIG. 20, the GUI facilitates scheduling work orders from the view using three simple operations. First one or a number of work orders from the interface is selected (by selecting the work orders via a mouse or other pointing device for example); then an option such as a crew and/or shift to perform the work is identified 2102. Lastly, a period such as a week or day is similarly selected (such as from a calendar widget 2104), as depicted in FIG. 20.

As the various information is provided through the interface, the KPIs are updated, as applicable by Scheduler 104 in real-time, to provide assistance with the scheduling decisions. The “tentative” un-committed scheduling data is maintained by Scheduler 104 until instructed by the user to make an EAM database update. As such the user can make different scheduling decisions and see the KPI results before committing. As other users (foremen, trades people) view work orders and KPI data on another PC while the user makes a scheduling decision, and as the tentative data is not updated, the other users do not receive a false picture of the EAM database data. Completing these three scheduling operations, and committing the data to the database, instantiates the corresponding fields in the work orders, thus completing the schedule for those work orders.

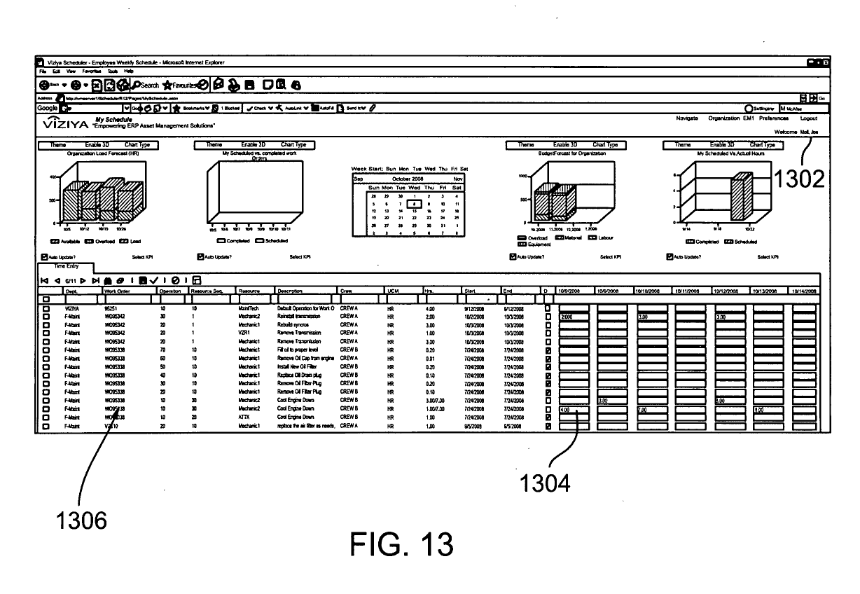

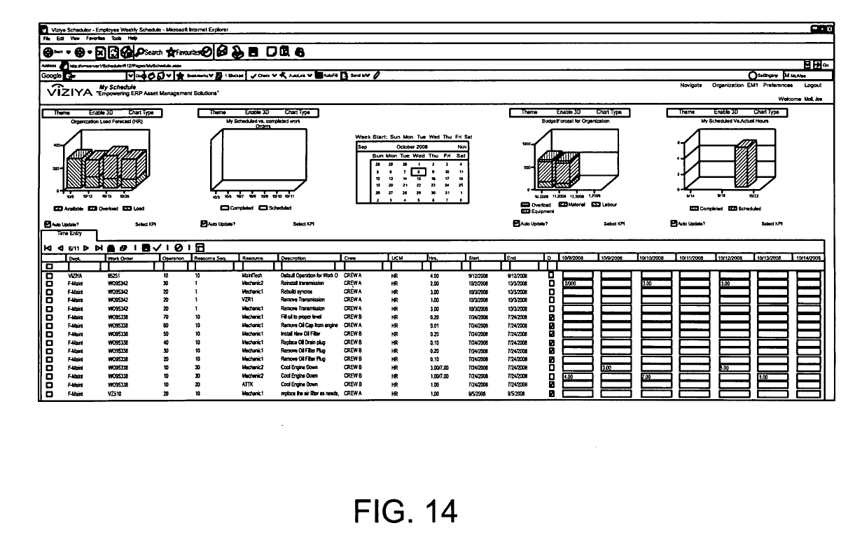

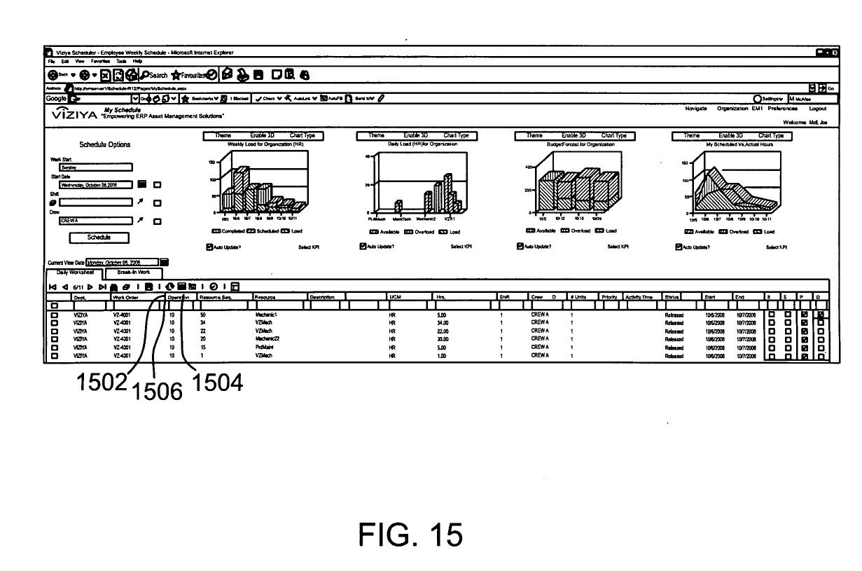

In accordance with user profiles, etc. certain users can have restricted access to the Scheduler application's user interface. In one embodiment, depicted in FIGS. 13 and 14 trades people are restricted to viewing only those work orders that they are scheduled to assist on 1306. As well, these users are also restricted in how they can manipulate those work orders. Similarly, FIG. 15 shows a foreman's view, in which the foreman (supervisor) can be restricted to viewing and manipulating only those work orders for which his or her trades people are scheduled to complete.

If a work order is scheduled to a particular week, for example, the trades foremen to whom it was scheduled can reschedule that work order for a more refined time-frame, such as to a particular day, similarly using the simple operations described above. The trades person may not, however, be given access to alter the work order in a less refined way, such as scheduling it from a particular day to a week or even changing the end or start time of the work order. For example, a foreman can assign a trades person a work order for a particular week and that trades person can schedule that same work order for a specific day within that week. If, however, the foreman schedules a work order to a trades person for a specific day, that trades person cannot change the scheduled day for that work order.

In one embodiment, the foreman is able to undertake certain operations on the work orders. If a work order is not completed on time, for example, the foreman can roll over the work order to the next day, by selecting the rollover button 1502. This changes the end date of that specific instance of the work order to the next day. Alternatively, the supervisor can hand work off to another crew and/or shift and/or day thereby allowing work to continue being worked on when it was not completed by the initial workers.

In one embodiment the foreman can also reschedule the work order, using a single mouse-click operation on the re-schedule button 1504 for example. What then transpires is that the work order is removed from the list of work orders that are deemed to be scheduled and is sent back into the backlog ready to be scheduled again and is then coloured purple in the backlog scheduling view so that it can be easily discerned by the user and dealt with expeditiously. This allows for situations in which the work order could not be completed within the time frame (week or day) that it had been scheduled for originally.

Similarly the foreman can undertake moving a work order operation 1506 which the foreman and his crew can undertake subsequently. This allows the foreman to change the start date and end date of the work order through a simple operation such as a mouse-click. A user can, however, only pick start and end dates within a period configurable by the customer during the implementation of the product, for example only within the week that the work was originally scheduled for.

Finally, from the foreman's view, resources can also be added by a simple operation, such as by performing a mouse-click to select the resource and a second mouse-click to select the work order and date. By facilitating different operations of rolling over, rescheduling and moving work orders, additional information for KPIs may be accumulated.

### Time Entry

As noted above, work order change data (start date, end date, resource, priority, or any other work order field for which changes are permitted) and other information entered via the user interface of PCs 1-3 are stored locally within Scheduler 104 and its tables 106 until committed to the database 102, as may be applicable.

FIGS. 13 and 14 show one embodiment of a trades persons' view. Through this view the trades person can type in the number of hours worked for each work order on a given day. In the depicted example Mr. Joe Moll 1302 is entering four hours on work order 95338 1304. The time entered by the trades person can be viewed by the foreman or other users depending on the restriction settings. The foreman or other user can then verify the hours worked and commit the new information to update the associated work orders (indicating the hours worked) to the EAM database via the Internet.

Once a foreman has validated the employee's hours and committed the updated work orders to the third-party database, the foreman's name can be attached to the committed updated work orders, thus providing valuable tracking information.

### Crew Building

The efficient and dynamic managing of crews can be accommodated by the crew building function such that necessary alterations to a schedule resulting from a typical maintenance-scheduling environment can be handled. Users can create crews that only allow certain selected employees from the EAM database to be assigned certain work orders. This allows for the dynamic and flexible grouping of workers into meaningful groups for the effective and efficient execution of the appropriate work.

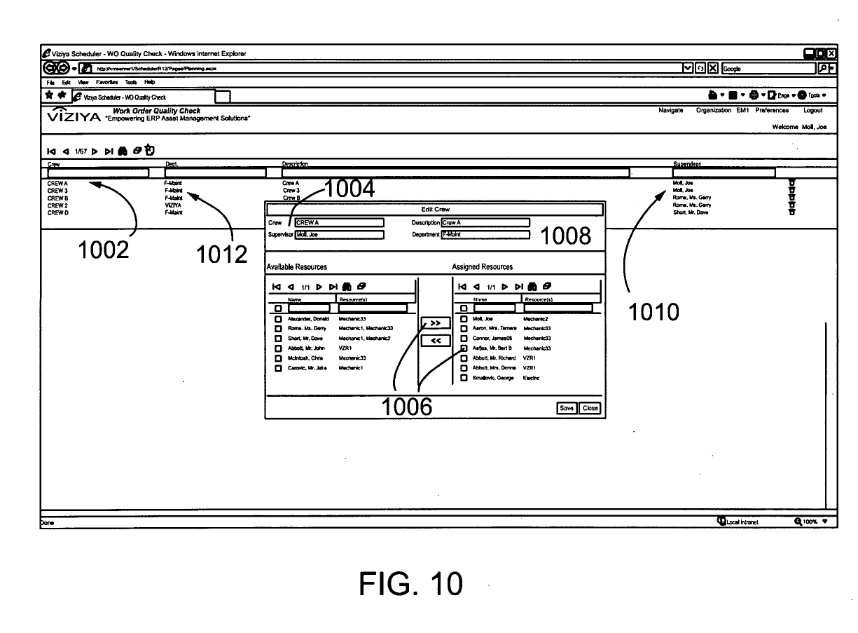

FIGS. 10, 11, and 12 depict screen shots of one embodiment of the crew building function. FIG. 10 shows the existing crews 1002 available to the users of the Scheduler. Crews can be edited by selecting one of the listed crews, Crew A 1004 as shown in FIG. 10 for example, and proceeding to select and assign trades people 1006 using common user input devices. The description of the crew can also be changed by entering a description in the appropriate input space 1008. Other helpful information such as foreman or supervisor 1010 and department 1012 is displayed and can be similarly edited.

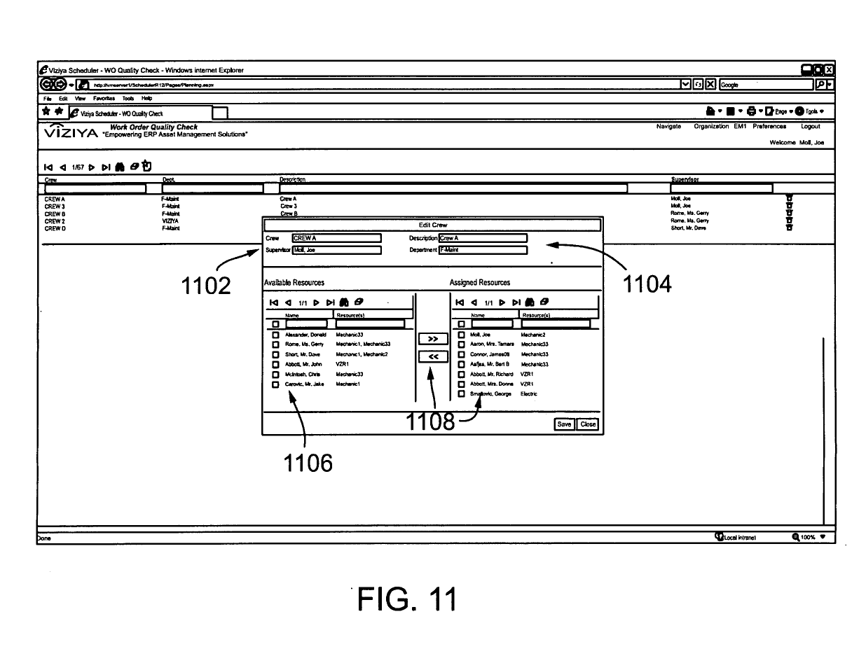

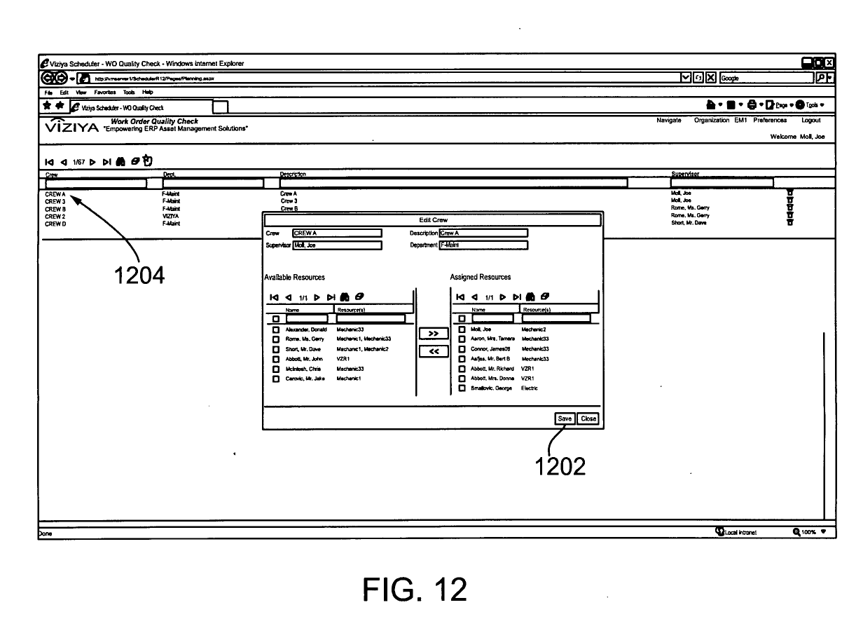

FIGS. 11 and 12 show one process for creating a new crew. To create a new crew, first a crew name and department are entered 1102 into the appropriate space, then, optionally, the crew description is entered and supervisor is selected 1104. Once the department is selected the available trades people are shown 1106 and can be assigned to the crew 1108. When the save option is selected 1202 the crew is included on the list of crews 1204 with all available information shown.

Once a crew is built using the crew builder users can schedule work orders to crews, even if their EAM database would not normally be able to manage this. Crews can enter their hours worked for each work order for each day into an interface similarly to that for employees in FIGS. 13 and 14. The foreman's view provides a view that lists the work orders that need to be completed on a given day along a left of the screen. The employees that have been assigned to a crew are listed along the top of the screen in a grid view. User's, such as foremen or employees, can then enter the amount of time worked a each work order into the corresponding junction-point matching the work order to the employee. Once the time is committed information such as who executed the work, when, for how long and against which work order's operation will be saved into the EAM database.

The user can also use the Availability function within the application to track the exact combination of person, day, crew, shi, resource type and hours scheduled. This allows for a quick update ability where the user can keep detailed, accurate and up to date records of such availability. It is this availability which is used within the KPIs to notify the user of the resource availability loads and overloads.

### Key Performance Indicators

Throughout all stages of the Scheduler a plurality, and in one embodiment more than thirty, KPIs are determined and maintained by the Scheduler and are provided (or selectively provided on demand) for display to users. These include statistical breakdowns measuring variables and outcomes dependant on the instantiations of the work orders.

When any of the work order instantiations is altered in any way, through one of the above operations for example, the KPIs are updated in real-time and can be displayed instantaneously on the same screen as the work orders. The KPIs can be determined using the tentative data that is not yet committed to the database 102 to help inform scheduling decisions.

Selected KPIs can be displayed in graphical form on any of the views described above (see FIG. 3 for example). When a work order instantiation is altered, the displayed KPIs are also altered in real-time thus indicating the effect of the alteration through the selected KPIs prior to committing the altered work order to the EAM database.

Other KPIs can be selected from any of the above described views to be shown on the screen.

For example, one embodiment of a KPI is a scheduled vs. actual hours KPI as depicted in FIG. 13. The graph is created by determining the total number of hours that were scheduled for the work assigned to his crew as opposed to the number of actual hours entered against those work orders in actuality, which can be calculated by those skilled in the art. The information in the graph is determined using the data of tables 106, work order data from database 102 as well as tentative data not yet committed to the database 102 as may be applicable. Other KPIs are similarly manifested.

The KPIs can use the transactional records in the tables 106 which are maintained for every event that has occurred during the scheduling process. In the tables 106 a transactional record of every event that has occurred during the scheduling process may be maintained and not just a list of the staged work orders before they are posted back to the primary ERP system. Hence, users may be provided with a capability to create reports to show what happened to every work order over the life of its scheduling process (how many times was it scheduled and then re-scheduled, was it rolled over, handed off, when to whom why, etc). Such reports and analysis of the scheduling process may help to determine how to schedule better and how to optimize the resources better. Also, such transactional records enable the ability to look at a snapshot of the coming schedule at any point in time looking forward and then do a reverse look at the schedule after the fact, thereby providing a snap-shot analysis of the schedule and compliance to the schedule.

KPIs include, but are not limited to:

a. My Completed Work orders

b. Completed Work Order Effectiveness

c. My Work Order Schedule

d. My Work Order Hours

e. Work Order Planning Hours vs. Actual Hours

f. Monthly Work Mix by Priority

g. Percentage Utilization by Crew

h. Percentage Utilization by Employee

i. Work Order Schedule Compliance

j. Percentage of Re-Planned Work Orders

k. Labor Breakdown by Work Type

l. Monthly Work Order Total

m. Man Days of Work in Backlog

n. Completed Work Order Profile by Maintenance Types

o. Workload Profile (Planned and Scheduled vs. Overdue)

p. Service Completion

q. Schedule Completion

r. Schedule Completion Hours

s. Scheduled Work

t. Scheduled Work Hours

u. Schedule Loading

v. Planned Jobs

w. Planned Job Hours

x. Backlog Size

y. Immediate Work

z. PM Finds (Follow Up Work Generated by PMs)

aa. Cancelled Work

bb. Completed Work Order Profile by Planned/Unplanned/Immediate.

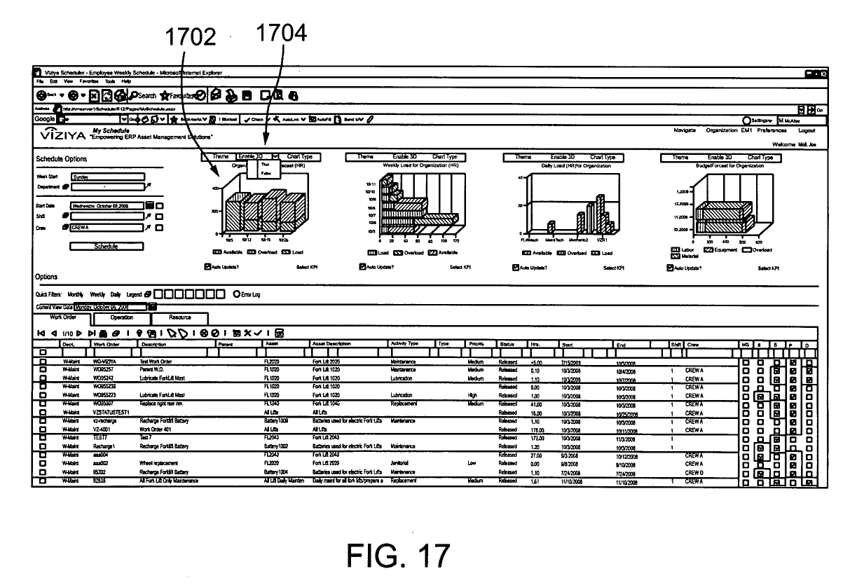

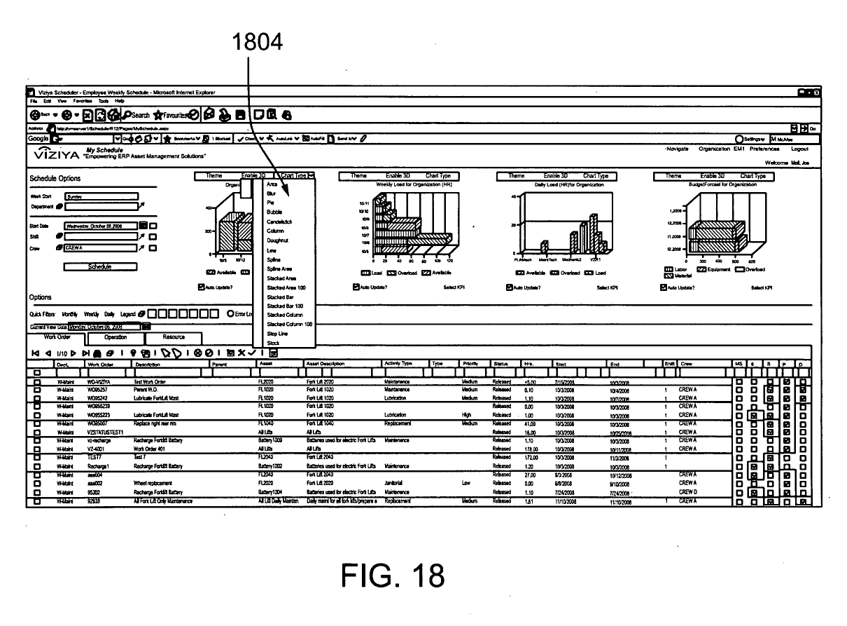

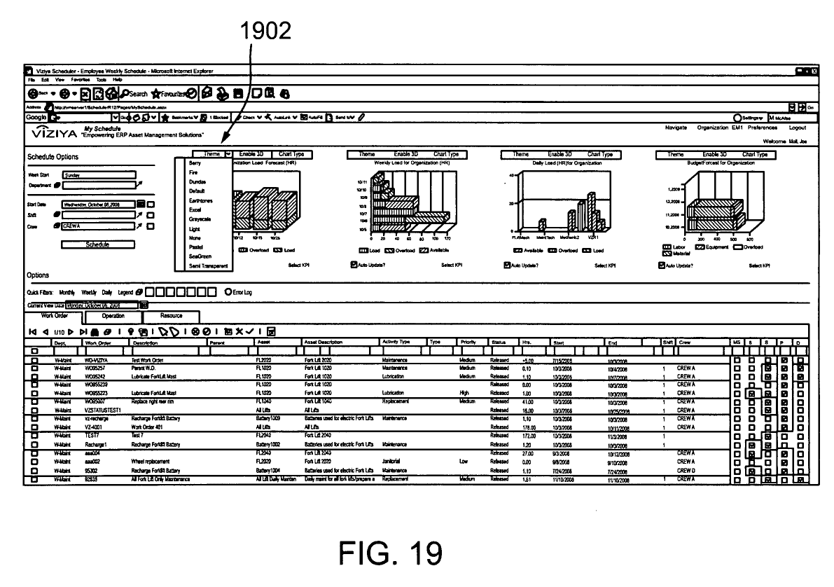

FIGS. 17, 18 and 19 show how a user can manipulate the method of viewing the KPIs while on the same interface as the work order list. The graph display of the KPI 1702 can be shown in three-dimensions or two-dimensions by selecting the corresponding choice in the drop-down menu 1704. Similarly a user can view the information in any one of 18 different graph types 1802. A user can also view the graph using different supplied themes 1902, whereby such themes allow for ease of gathering information from the KPI graph.

Advantageously, Scheduler 104 facilitates the scheduling of work orders for completion by appropriately qualified personnel, by the best time as dictated by the organization's capacity and by the work order's level of priority. It also simultaneously provides numerous real-time statistical depictions of the schedule's efficiency and load, for example, in the same interface as that showing the schedule. Such depictions could also be used to immediately compare different schedules in order to assist in selecting a particular scheduling solution. Scheduling operations may be invoked within as little as a three-click effort: Click on the date to schedule to, Click on the work orders to schedule, Click on the schedule button to tentatively schedule the work orders—(the first two steps may be performed in a different order). Once the user is satisfied that the tentative scheduling is acceptable (for example, in response to reviewing the KPIs), the user can then post the changes to the primary ERP system.

A work order scheduled to be completed by a certain group of personnel, or a crew, for a time in the future may be effected such that the schedule no longer reflects the most efficient use of the organization's resources. An ideal method of scheduling will have the flexibility to dynamically respond to such changing circumstances.

A number of other situations such as unforeseen work stoppages or disruptions can render an organization's schedule unusable. Organizations thus require a flexible, dynamic, and easy to manipulate automated, real-time scheduling system.

Many scheduling systems use work orders from existing databases, such as Oracle eAM and SAP PM. Interactions with these databases often have potential for error due to client-server methods of communication. This type of communication requires that the schedule be saved on the client as well as on the server. Any error in coordination of client and server scheduling can lead to scheduling errors that can be difficult to reconcile. Scheduler 104 avoids such difficulties, minimizing this possibility of error by using Internet based communications with real-time connections to the production database such that the schedule need only be saved on and accessed from the server.

1. A method of scheduling work orders maintained within an enterprise resource planning (ERP) system, said method comprising:
providing a user interface for a scheduling application configured to schedule said work orders in said ERP system;
maintaining key performance indicator (KPI) information associated in real time with said work orders using said scheduling application;
presenting said KPI information via said user interface to facilitate decisions related to said scheduling; and
in response to user input scheduling selected work orders, committing changes to said selected work orders in said ERP system to implement the scheduling.

2. The method of claim 1 comprising:
in response to user input tentatively scheduling at least some of said work orders:
maintaining changes to said work orders by said scheduling application without committing said changes to said ERP system;
updating said KPI information; and
presenting the updated KPI information via said user interface.

3. The method of claim 2 comprising:
receiving user input specifying a particular date to schedule to;
receiving user input to specify particular work orders to schedule;
receiving user input to tentatively schedule the particular work orders to the particular date; and
tentatively scheduling in accordance with said user input to tentatively schedule.

4. The method of claim 3 comprising receiving user input to commit changes to said ERP system to schedule the tentatively scheduled work orders.

5. The method of claim 1 wherein the user interface is configured to present work orders from said ERP system in accordance with user selectable filters.

6. The method of claim 5 comprising presenting work orders from said ERP system in accordance with user selectable filters; and wherein the user interface is configured to selectively associate one or more of said work orders presented in accordance with said filters with resources to perform said work orders and a time period for performing said work orders in response to user input to schedule said work orders.

7. The method of claim 5 wherein said scheduling application is configured to plan said work orders and said user interface is configured to permit a user to selectively verify, using planning rules, one or more of said work orders presented in accordance with said filters.

8. The method of claim 7 wherein the user interface is configured to define particular planning rules in response to user input.

9. The method of claim 7 wherein the user interface is configured to receive changes to work orders and selectively commit said changes to said ERP system to plan said work orders fro scheduling.

10. The method of claim 1 where in the user interface is web-based.

11. The method of claim 1 wherein the scheduling application cooperatively executes with the ERP system using ERP system APIs.

12. The method of claim 1 wherein the user interface is configured to present work orders and KPI information and receive work order changes in accordance with user profiles to restrict users to performing certain scheduling and work order change functions.

13. The method of claim 1 comprising maintaining transaction records for each work order as it is scheduled.

14. The method of claim 13 comprising providing a user interface for said transaction records for analyzing a scheduling process.

15. A computer system comprising one or more servers and user computers coupled thereto via a communication network for performing a method of scheduling work orders maintained within an enterprise resource planning (ERP) system, said method comprising:
providing a user interface for a scheduling application configured to schedule said work orders in said ERP system;
maintaining key performance indicator (KPI) information associated in real time with said work orders using said scheduling application;
presenting said KPI information via said user interface to facilitate decisions related to said scheduling; and
in response to user input scheduling selected work orders, committing changes to said selected work orders in said ERP system to implement the scheduling.

16. The computer system of claim 15 wherein the method performed comprises:
in response to user input tentatively scheduling at least some of said work orders:
maintaining changes to said work orders by said scheduling application without committing said changes to said ERP system;
updating said KPI information; and
presenting the updated KPI information via said user interface.

17. The computer system of claim 16 wherein the method performed comprises:
receiving user input specifying a particular date to schedule to;
receiving user input to specify particular work orders to schedule;
receiving user input to schedule the particular work orders to the particular date; and
tentatively scheduling in accordance with said user input to schedule.

18. The computer system of claim 17 wherein the method performed comprises receiving user input to commit changes to said ERP system to schedule the tentatively scheduled work orders.

19. The computer system of claim 15 wherein the scheduling application is configured to plan said work orders and said user interface is configured to permit a user to selectively verify, using planning rules, one or more of said work orders presented in accordance with said filters.

20. A computer program product comprising instructions and data for execution by a processor to implement a method of scheduling work orders maintained within an enterprise resource planning (ERP) system, said method comprising:
providing a user interface for a scheduling application configured to schedule said work orders in said ERP system;
maintaining key performance indicator (KPI) information associated in real time with said work orders using said scheduling application;
presenting said KPI information via said user interface to facilitate decisions related to said scheduling; and
in response to user input scheduling selected work orders, committing changes to said selected work orders in said ERP system to implement the scheduling.
